(19) United States
(12) Patent Application Publication
(10) Pub. No.: US 2013/0299242 A1
(43) Pub. Date: Nov. 14, 2013

(54) SYSTEM AND METHOD FOR IDENTIFYING A BALLOONING ZONE

(71) Applicant: Daniel Marco Veeningen, Houston, TX (US)

(72) Inventor: Daniel Marco Veeningen, Houston, TX (US)

(73) Assignee: INTELLISERV, LLC, Houston, TX (US)

(21) Appl. No.: 13/471,063

(22) Filed: May 14, 2012

(51) Int. Cl. E21B 47/00; G06F 19/00; G01V 3/18

(52) U.S. Cl. 175/50; 702/7

(57) ABSTRACT

A method and apparatus for identifying a ballooning zone in downhole formations. In one embodiment, a method for identifying a ballooning zone in downhole formations includes disposing a drill string in a wellbore. The drill string includes a plurality of wired drill pipes connected end-to-end, and a bottomhole assembly connected to the drill pipes. While circulating drilling fluid through the wellbore, a first resistivity of a formation drilled is measured. While not circulating drilling fluid through the wellbore, a second resistivity of the formation drilled is measured. The first resistivity and the second resistivity are compared. Based on a result of the comparing, a level of ballooning attributable to the formations is identified.

### BACKGROUND

When drilling earthen formations in pursuit of hydrocarbons or other resources, drilling fluid, also known as “mud,” is pumped into the wellbore. The drilling fluid lubricates the drill bit, transports borehole cuttings to the surface, and maintains wellbore pressure. During drilling, a phenomenon referred to as “ballooning” may occur. Ballooning refers to an effect in which the drilled formations absorb drilling fluid while drilling fluid is pumped into the wellbore and discharge the absorbed drilling fluid when the pumping is discontinued. The ballooning effect arises from the equivalent circulating density (ECD) of the drilling fluid. ECD is an increase in downhole pressure that occurs when drilling fluid is being circulated. The friction of fluid flow in the wellbore annulus significantly increases the downhole pressure while the fluid pumps are operating relative to the pressure when the pumps are not operating. Consequently, during periods of fluid circulation, the increased fluid pressure causes the drilling fluid to enter fractures or micro-fractures that are present in certain formations. When the ECD is eliminated, i.e., when fluid is not circulating and consequently the downhole fluid pressure is decreased, the fractures close and drilling fluid returns from the formations to the wellbore. Such fluid returns frequently occur when drill pipe connections are made.

A fluid level increase may also be caused by “kick.” A kick may occur when the pressure of the fluids in the formations being drilled accidentally or intentionally exceeds the pressure of the drilling fluid in the wellbore. Under such conditions, an under balance situation arises, and fluid flows from the formations into the wellbore. A kick is a safety concern in drilling operations as the hydrocarbons flowing from the drill formations can interfere with mud flow and upon reaching the surface can inadvertently be set aflame or caused to explode.

Because fluid level increase is an indicator of fluid flow from the formations into the wellbore, such as occurs with a kick, fluid level while drilling is diligently monitored. Unfortunately, relatively harmless fluid gain from ballooning may not be readily distinguishable from the potentially dangerous fluid gain due to a kick. Therefore, techniques for identifying ballooning and differentiating ballooning from a potentially dangerous kick are desirable.

### SUMMARY

A method and apparatus for identifying a ballooning zone in downhole formations is herein disclosed. In one embodiment, a method for identifying a ballooning zone in downhole formations includes disposing a drill string in a wellbore. The drill string includes a plurality of wired drill pipes connected end-to-end, and a bottomhole assembly connected to the drill pipes. While circulating drilling fluid through the wellbore, a first resistivity of a formation drilled is measured. While not circulating drilling fluid through the wellbore, a second resistivity of the formation drilled is measured. The first resistivity and the second resistivity are compared. Based on a result of the comparing, a level of ballooning attributable to the formations is identified.

In another embodiment, a system for identifying a ballooning zone includes a drill string and a formation analyzer. The drill string includes a plurality of wired drill pipes communicatively coupled end-to-end, and a bottomhole assembly. The bottomhole assembly includes a tool configured to measure formation resistivity. The formation analyzer is configured to compare a first formation resistivity value of a wellbore formation measured by the tool while drilling to a second formation resistivity value of the wellbore formation measured by the tool while not pumping drilling fluid into the wellbore. The formation analyzer is also configured to classify the formation as belonging to one of a plurality of ballooning levels based on a result of the comparison.

In a further embodiment, a formation analyzer for identifying a ballooning zone includes one or more processors and ballooning analysis logic. When executed, the ballooning analysis logic causes the one or more processors to compare a first formation resistivity value of a wellbore formation measured, while circulating drilling fluid through the wellbore, by a logging while drilling formation resistivity measurement tool to a second formation resistivity value of the wellbore formation measured by the tool, while not circulating drilling fluid through the wellbore. The ballooning analysis logic also causes the one or more processors to determine whether the wellbore formation causes ballooning based on a result of the comparison.

### BRIEF DESCRIPTION OF THE DRAWINGS

For a detailed description of exemplary embodiments of the invention, reference is now be made to the figures of the accompanying drawings. The figures are not necessarily to scale, and certain features and certain views of the figures may be shown exaggerated in scale or in schematic form in the interest of clarity and conciseness.

FIG. 1 shows a system for identifying a ballooning zone in downhole formations in accordance with principles disclosed herein;

FIG. 2 shows a block diagram for a formation analysis system configured to identifying a ballooning zone in accordance with principles disclosed herein;

FIG. 3 shows a plot of exemplary wellbore formation resistivity measured while drilling;

FIG. 4 shows a plot of exemplary wellbore formation resistivity measured while not circulating drilling fluid;

FIG. 5 shows a plot of wellbore formation resistivity overlaid with formation ballooning classifications determined in accordance with principles disclosed herein; and

FIG. 6 shows a flow diagram for a method for identifying a ballooning zone in accordance with principles disclosed herein.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through direct engagement of the devices or through an indirect connection via other devices and connections. The recitation “based on” is intended to mean “based at least in part on.” Therefore, if X is based on Y, X may be based on Y and any number of other factors.

### DETAILED DESCRIPTION

The following discussion is directed to various embodiments of the invention. The embodiments disclosed should not be interpreted, or otherwise used, to limit the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

While ballooning and a kick both produce a wellbore fluid gain, there are distinctive differences between a kick and the ballooning effect. With a kick, the rate of fluid gain rate will increase over time, while the rate of fluid gain decreases over time for ballooning. Furthermore, the shut-in pressure cannot exceed the equivalent circulating density (ECD) value in the case of the ballooning effect, while the shut-in pressure is limitless in case of a kick. Unfortunately, reliable techniques for measuring downhole fluid flow are lacking, and establishing the shut-pressure in order to identify ballooning is not feasible in practice due, for example, to excessive wear on the blow-out preventer that would result.

Embodiments of the present disclosure perform logging-while-drilling (LWD) downhole resistivity propagation log measurements during periods when ECD is applied (e.g., the time that the formation is being drilled) and periods without ECD (e.g., when drilling is halted). Embodiments compare the logs to identify wellbore zones that cause the ballooning effect due to fractures, micro fractures, etc. Thus, embodiments provide information indicating whether a wellbore fluid gain may be caused by ballooning rather than a kick.

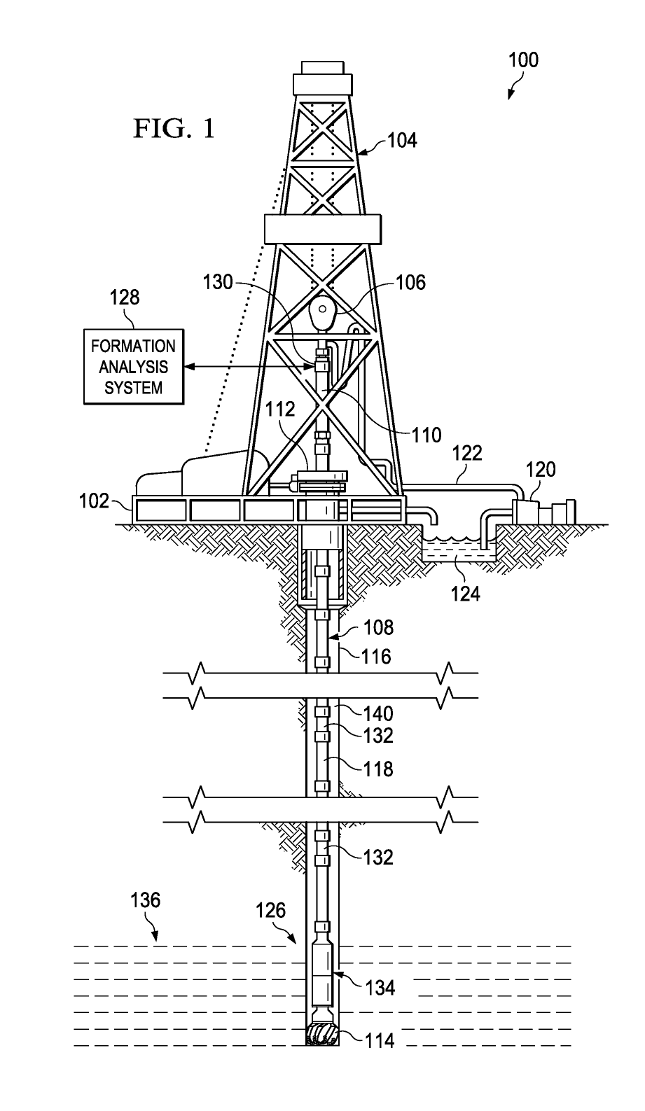

FIG. 1 shows a system 100 for identifying a ballooning zone in downhole formations in accordance with principles disclosed herein. In the system 100, a drilling platform 102 supports a derrick 104 having a traveling block 106 for raising and lowering a drill string 108. A kelly 110 supports the drill string 108 as it is lowered through a rotary table 112. In some embodiments, a top drive is used to rotate the drill string 108 in place of the kelly 110 and the rotary table 112. A drill bit 114 is positioned at the downhole end of a bottomhole assembly 126, and is driven by rotation of the drill string 108 or by a downhole motor (not shown) positioned in the bottomhole assembly 126 uphole of the drill bit 114. As the bit 114 rotates, it removes material from the various formations 136 and extends the wellbore 116. A pump 120 circulates drilling fluid through a feed pipe 122 and downhole through the interior of drill string 108, through orifices in drill bit 114, back to the surface via the annulus 140 around the drill string 108, and into a retention pit 124. The drilling fluid transports cuttings from the wellbore 116 into the pit 124 and aids in maintaining the integrity of the wellbore 116.

While the pump 120 is on, annular pressure loss or friction effects cause the ECD to exceed the static hydrostatic density, and drilling fluid may enter fractures and microfractures in the formations 136. As a result, the drilling fluid circulation system loses fluid. In some situations the microfractures in the formations 136 may propagate, causing loss of a large volume of drilling fluid into the formation 136. When drilling fluid circulation is halted (i.e., the pump 120 is turned off), annular friction effects are eliminated and ECD is reduced to the static hydrostatic density. In response to the reduced pressure, the fractures and microfractures in the near-wellbore area (i.e., the formations 136 near the wellbore 116) close and the drilling fluid flows from the formations 136 back into the wellbore 116, causing a fluid gain in the drilling fluid circulation system.

In the system 100, the drill string 108 includes a plurality of sections (or joints) of wired drill pipe 118. Each section of wired drill pipe 118 includes a communicative medium (e.g., a coaxial cable, twisted pair, etc.) structurally incorporated or embedded over the length of the section, and an interface at each end of the section for communicating with an adjacent section. The communicative medium is connected to each interface. In some embodiments, the interface may include a coil about the circumference of the end of the section for forming an inductive connection with the adjacent section of wired drill pipe. The high bandwidth of the wired drill pipe 118 allows for transfers of large quantities of data at a high transfer rate, and provides communication between the bottomhole assembly 126 and the surface without requiring circulation of drilling fluid. The drill string 108 may also include wired drill pipe telemetry repeaters 132 that are distributed among the wired drill pipes 118. The telemetry repeaters 132 regenerate wired drill pipe telemetry signals and extend the reach of the wired drill pipe telemetry network formed by the wired drill pipes 118. A surface sub 130 communicatively couples the wired drill pipes 118 to surface processing systems, such as the formation analysis system 128.

The bottomhole assembly 126 includes a tool 134 for measuring the resistivity of the formations 136 while the borehole 116 is being drilled. The tool 134 may be a propagation resistivity logging-while-drilling tool. A propagation resistivity logging tool includes one or more transmitters and one or more receivers. Each transmitter induces an electromagnetic field in the formations adjacent to the tool 134 at one or more frequencies (e.g., 400 kilohertz (KHz), 2 megahertz (MHz), etc.). The receivers measure the amplitudes and phase shifts of the induced magnetic fields which are affected by the properties of the formation. The received signals are processed to determine the resistivity of the formation. The tool 134 communicates resistivity measurements to the surface via the wired drill pipe telemetry network.

The formation analysis system 128 processes the resistivity measurements provided by the resistivity tool 134 to determine whether, and to what degree, the formations 136 are subject to ballooning. As the wellbore 116 is being drilled, the resistivity tool 134 is measuring the resistivity of the formations 136 drilled and providing the formation resistivity measurements to the formation analysis system 128. When drilling, and in turn drilling fluid circulation, is halted (e.g., to add drill pipe 118 to the drill string 108) the bottomhole assembly 126 and the resistivity tool 134 may be retracted uphole and measure the resistivity of the previously formations drilled for a second time. The resistivity tool 134 provides the second resistivity measurements to the formation analysis system 128.

The measured resistivity of the formations 136 is a function of the formation-type, fluid content in the pores and (micro)fractures of the formations 136, and the volume measured. The resistivity characteristics of a measured volume with drilling fluid invading fractures and micro fractures of the formations 136 is different from the same volume after the drilling fluid has been expelled.

The formation analysis system 128 processes and compares the two sets of resistivity measurements to determine whether the formations 136 may cause ballooning. Based on the determination of the formation analysis system 128, the nature of a fluid gain may be better understood, and/or operations to reduce fluid loss due to ballooning may be initiated.

While the system 100 is illustrated with reference to an onshore well and drilling system, embodiments of the system 100 are also applicable to identifying formations that cause ballooning in offshore wells. In such embodiments, the drill string 108 may extend from a surface platform through a riser assembly, a subsea blowout preventer, and a subsea wellhead into the formations 118.

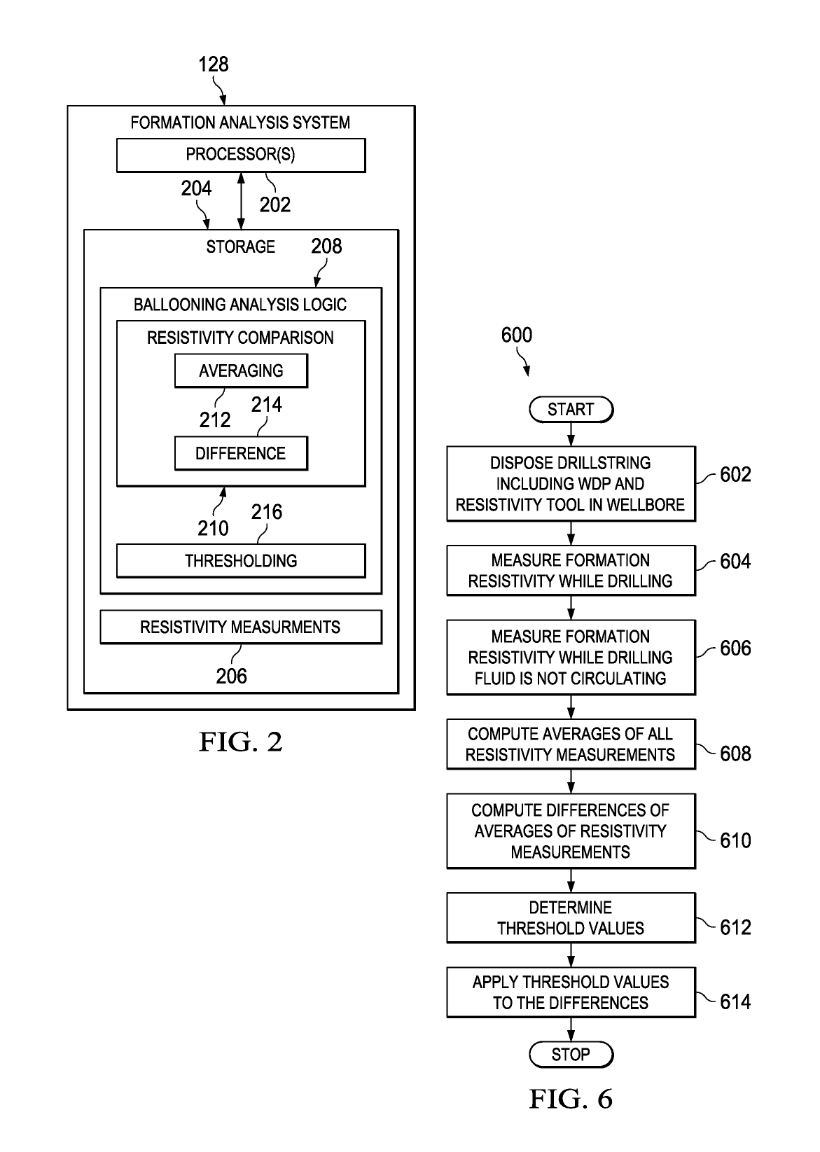

FIG. 2 shows a block diagram for the formation analysis system 128 configured to identify formations that cause ballooning in accordance with principles disclosed herein. The formation analysis system 128 includes one or more processors 202 and storage 204 coupled to the processor(s) 202. The formation analysis system 128 may also include various communication systems that provide for input of data to the formation analysis system 128 and output of data from the formation analysis system 128. For example, the formation analysis system 128 may include wired and or wireless network interfaces (e.g., IEEE 802.3, IEEE 802.11, etc.), user input interfaces (universal serial bus, keyboard, pointing device, etc.), data display interfaces (monitors, plotters, etc.), and the like. Some embodiments of the formation analysis system 128 may be implemented using computers, such as desktop computers, laptop computers, rack-mount computers, or other computers known in the art.

The processor(s) 202 may include, for example, one or more general-purpose microprocessors, digital signal processors, microcontrollers, or other suitable instruction execution devices known in the art. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems.

The storage 204 is a non-transitory computer-readable storage device and includes volatile storage such as random access memory, non-volatile storage (e.g., a hard drive, an optical storage device (e.g., CD or DVD), FLASH storage, read-only-memory), or combinations thereof. The storage 204 includes resistivity measurements 206 received from the resistivity tool 134, and ballooning analysis logic 208. The ballooning analysis logic 208 includes instructions for processing the resistivity measurements 206 and determining whether the resistivity measurements indicate that a formation 136 corresponding to the measurements causes ballooning. Processors execute software instructions. Instructions alone are incapable of performing a function. Therefore, any reference herein to a function performed by software instructions, or to software instructions performing a function is simply a shorthand means for stating that the function is performed by a processor executing the instructions.

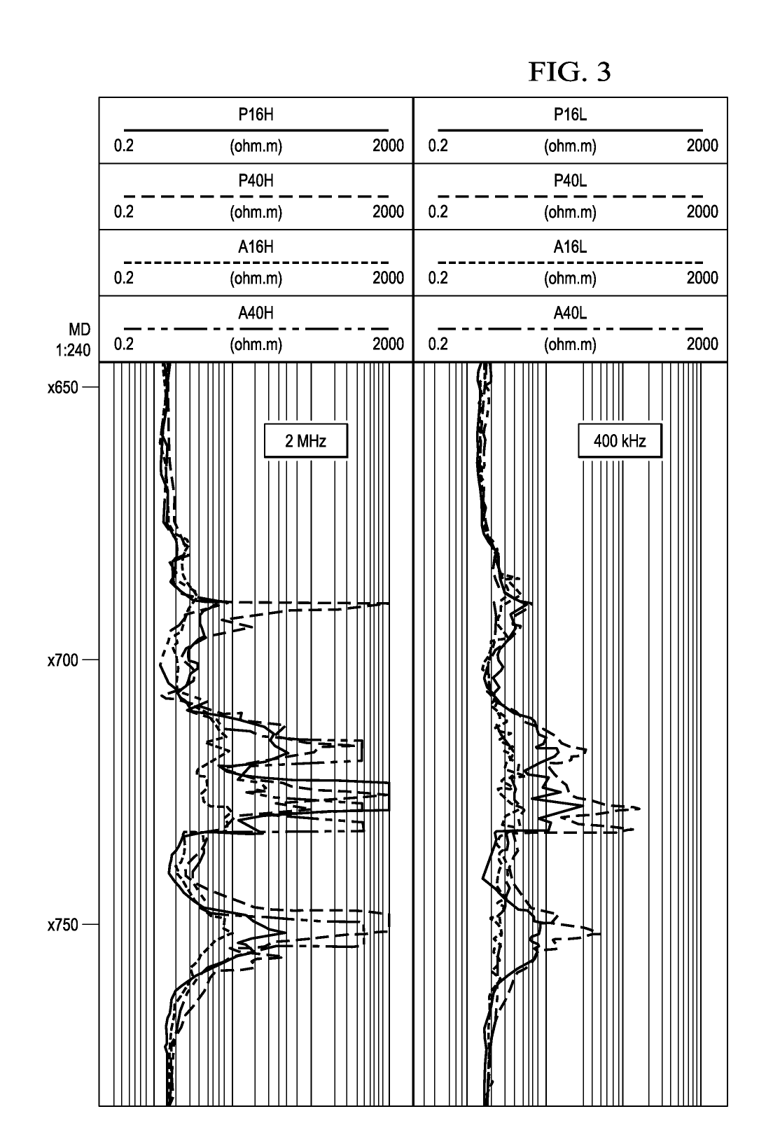

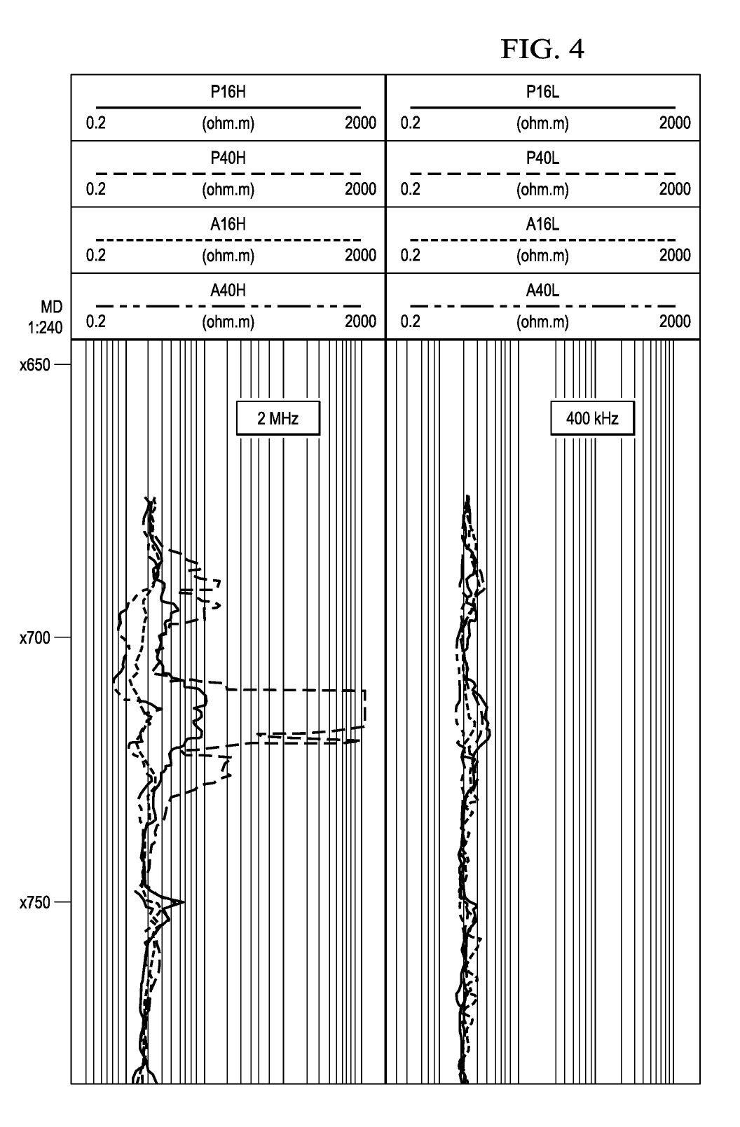

As explained above, the resistivity tool 134 provides the formation analysis system 128 with two sets of formation resistivity measurements—a first set acquired during circulation of drilling fluid through the wellbore 116, and a second set acquired after drilling fluid circulation has been halted. FIG. 3 shows a plotted set of exemplary wellbore formation resistivity measurements for the wellbore 116 acquired during a first logging pass while drilling the formations 136 (i.e., while circulating drilling fluid), and FIG. 4 shows a plotted set of exemplary wellbore formation resistivity measurements acquired for the formations 136 during a second logging pass while not circulating drilling fluid drilling through the wellbore 116 (e.g., while not drilling). In FIGS. 3 and 4, resistivity attenuation and phase data have been acquired for different depths of investigation at 400 KHz and 2 MHz. Some embodiments may acquire different resistivity data and/or apply different frequencies and/or different depths of investigation.

The two sets of resistivity measurements are stored as resistivity measurements 206. The resistivity comparison module 210 processes and compares the measurements of the first set to the measurements of the second set to determine a degree of difference between the measured resistivity values.

In some embodiments of the resistivity comparison module 210, an average of each parameter of a resistivity measurement is computed by the averaging module 212. For example, if propagation resistivity phase and attenuation measurements are made at 400 KHz and 2 MHz with and without drilling fluid circulation, then eight different resistivity values may each be averaged. Some embodiments of the averaging module 212 compute a moving average over each resistivity value R as:

$${Avg}_{R} = \frac{{R}_{M} + {R}_{M - 1} + {R}_{M - 2} + … + {R}_{M - n}}{n} ,$$

where n is the number of resistivity values averaged. In some embodiments, the resistivity values R are measured and recorded at 6 inch intervals, and Avg_{R} is computed over 10 feet, requiring 20 resistivity measurements R for each Avg_{R} value computed. Thus, in such embodiments, n=20. Other embodiments, may average over a different interval or implement the averaging differently (e.g., by low pass filter).

For the eight resistivity value example, the averaging module 212 produces:

Avg_{R}_{_{400,Atten,C}},

Avg_{R}_{_{400,phase,C}},

Avg_{R}_{_{2000,Atten,C}},

Avg^{R}_{_{2000,Phase,C}},

Avg_{R}_{_{400,Atten,NC}},

Avg^{R}_{_{400,Phase,NC}},

Avg_{R}_{_{2000,Atten,NC}}, and

Avg_{R}_{_{2000,Phase,NC}},

where:
400 and 2000 correspond to 400 and 2000 KHz respectively,
Atten and Phase correspond to attenuation and phase measurements respectively, and
C and NC correspond to circulation and non-circulation of drilling fluid respectively.

The difference module 214 computes the difference of the averages computed by the averaging module 212. The difference may be computed as:

DBE_{Freq,PropType}=Avg_{R}_{_{Freq,PropType,C}}−Avg_{R}_{_{Frq,PropType,NC}}

where:
Freq specifies the resistivity measurement frequency, 400 KHz, 2000 KHz, etc., and
PropType specifies attenuation measurement, phase measurement, etc.

Thus, for the eight resistivity value example, the difference module 214 produces:

DBE_{400,Atten}=Avg_{R}_{_{400,Atten,C}}−Avg_{R}_{_{400,Atten,NC}},

DBE_{2000,Atten}=Avg_{R}_{_{2000,Atten,C}}−Avg_{R}_{_{2000,Atten,NC}},

DBE_{400,Phase}=Avg_{R}_{_{400,Phase,C}}−Avg_{R}_{_{400,Phase,NC}}, and

DBE_{400,Phase}=Avg_{R}_{_{2000,Phase,C}}−Avg_{R}_{_{200,Phase,NC}},

where the difference value is termed the dynamic ballooning effect (DBE).

The thresholding module 216 determines threshold values for comparison to the DBE values. In some embodiments, threshold values for each frequency and propagation type (e.g., attenuation and phase) may be determined. The threshold values may be determined, for example, based on the measured resistivity values. In some embodiments, the thresholds may be a determined as a percentage of the maximum measured resistivity value at a given depth.

Embodiments may compare one or more threshold values to the DBE values to classify the ballooning potential of the formations. For example, when employing two threshold values, if DBE at a given depth exceeds a HIGH ballooning threshold value, then the formations at the given depth may be classified as having a high potential for ballooning. If DBE at a given depth is less than a LOW ballooning threshold value, then the formations at the given depth may be classified as having a low potential for ballooning. If DBE at a given depth falls between LOW and HIGH ballooning threshold values, then the formations at the given depth may be classified as having a medium potential for ballooning.

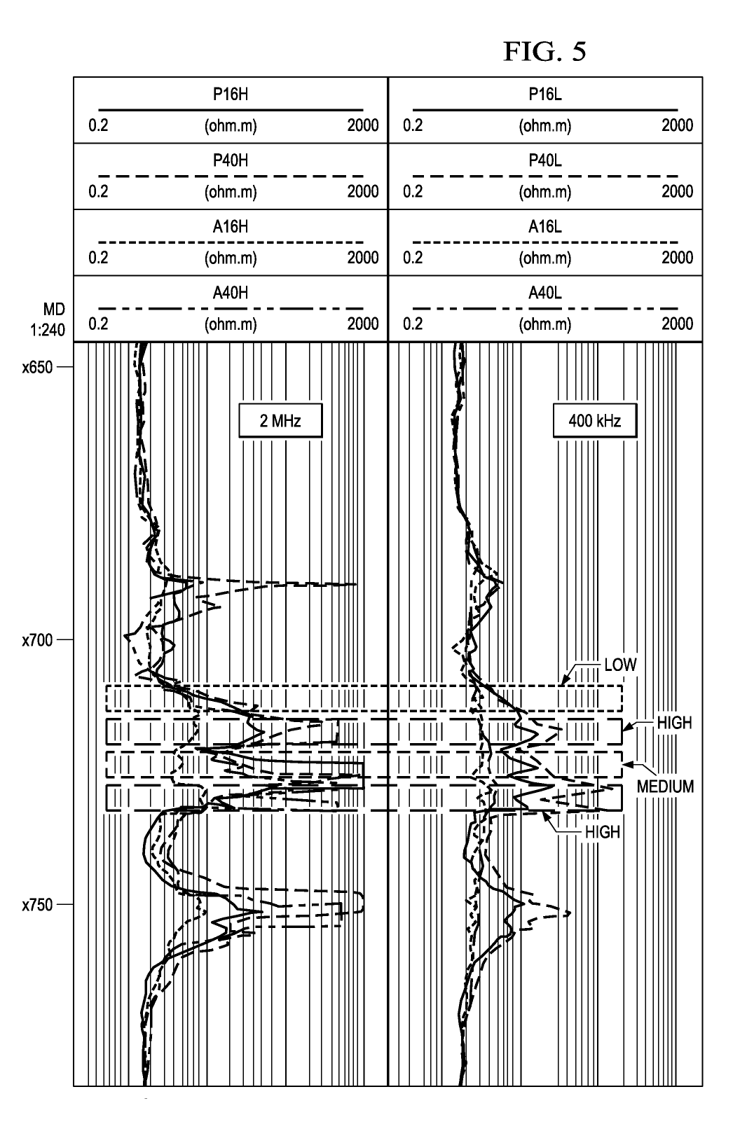

FIG. 5 shows a plot of wellbore formation resistivity overlaid with formation ballooning classifications determined in accordance with principles disclosed herein. In FIG. 5, resistivity data has been processed and formations at a selected range of wellbore depths have classified, as described above, as having a potential for low, medium, or high ballooning. The thresholding module 216 determined and applied a LOW threshold value of 500 ohm-m and a HIGH threshold value of 1000 ohm-m to the DBE values to classify the formations 136. Based on the classifications, wellsite personnel gain an understanding of the potential for ballooning presented by the drilled formations 136, and may determine whether corrective actions should be taken.

FIG. 6 shows a flow diagram for a method 600 for identifying a ballooning zone in accordance with principles disclosed herein. Though depicted sequentially as a matter of convenience, at least some of the actions shown can be performed in a different order and/or performed in parallel. Additionally, some embodiments may perform only some of the actions shown. At least some of the operations of the method 600 can be performed by the processor(s) 202 executing instructions read from a computer-readable medium (e.g., the storage 204).

In block 602, the drillstring 108 is disposed in the wellbore 116. The drillstring 108 includes a LWD resistivity measurement tool 134, and a wired drill pipe telemetry system comprising a plurality of joints of wired drill pipe 118.

In block 604, the wellbore 116 is being drilled. While drilling, drilling fluid is being circulated through wellbore 116 via the drillstring 108 and the annulus 140. The resistivity of the formations 136 being drilled is measured by the resistivity measurement tool 134 while drilling. Via the wired drill pipe telemetry system, the resistivity measurement tool 134 transmits the resistivity measurements to the formation analysis system 128 at the surface.

In block 606, drilling of the wellbore 116 and circulation of the drilling fluid through the drillstring 108 and the annulus 140 has halted. For example, drilling may be halted to allow addition of drill pipes 118 to the drillstring 108. While the drilling fluid is not circulating through the wellbore 116, the resistivity measurement tool 134 is moved past and measures resistivity of the previously drilled formations 136. For example, the drillstring 108 may pulled a predetermined distance out wellbore 116 (e.g., distance drilled since the last non-drilling resistivity measurements) and returned to the bottom of the wellbore 116 to move the resistivity measurement tool 134 past the previously drilled formations 136. Via the wired drill pipe telemetry system, the resistivity measurement tool 134 transmits the resistivity measurements to the formation analysis system 128 at the surface. Because the wired drill pipe telemetry system provides a high rate of data transfer to the formation analysis system 128, the resistivity measurement tool 134 may be moved past the previously drilled formations relatively quickly, thereby reducing the delay to drilling caused to the second resistivity measurement.

In block 608, the formation analysis system 128 computes an average of each resistivity measurement parameter received from the resistivity measurement tool 134. The resistivity measurements may include attenuation, phase, and/or other parameters for different resistivity measurement frequencies, and the formation analysis system 128 may compute an average for each frequency and parameter. The average may be computed as a moving average of each parameter. For example, a moving average computed by the formation analysis system 128 may average 20 adjacent measurement values per value of the average. In other embodiments, a different number of measurement values may be averaged, and/or a different algorithm may be applied to compute the averages (e.g., a finite impulse response filter).

In block 610, the formation analysis system 128 computes the differences between the averages of formation resistivity parameters acquired while circulating drilling fluid and formation resistivity parameters acquired while not circulating drilling fluid.

In block 612, the formation analysis system 128 determines threshold values that can be used to classify the formations with regard to potential for ballooning. The threshold values may be determined as a fraction of the maximum measured or average resistivity values. Multiple threshold values may be determined to generate multiple ballooning classifications. Different threshold values may be determined for each resistivity measurement parameter and frequency.

In block 614, the threshold values are compared to the difference between the resistivity averages. The drilled formations are assigned a ballooning classification based on the results of the comparisons.

The above discussion is meant to be illustrative of principles and various exemplary embodiments of the present invention. Numerous variations and modifications will become apparent to those skilled in the art once the above disclosure is fully appreciated. It is intended that the following claims be interpreted to embrace all such variations and modifications.

What is claimed is:

1. A method for identifying a ballooning zone in downhole formations, comprising:
disposing a drill string in a wellbore, the drill string comprising:
a plurality of wired drill pipes connected end-to-end; and
a bottomhole assembly connected to the drill pipes;
measuring, while circulating drilling fluid through the wellbore, a first resistivity of a formation drilled;
measuring, while not circulating drilling fluid through the wellbore, a second resistivity of the formation drilled;
comparing the first resistivity and the second resistivity;
identifying a level of ballooning attributable to the formations based on a result of the comparing.

2. The method of claim 1, wherein measuring the second resistivity comprises measuring resistivity of the formation via the bottomhole assembly.

3. The method of claim 1, further comprising determining whether a fluid gain is caused by ballooning based on the identifying.

4. The method of claim 1, further comprising transmitting measurements of the second resistivity to the surface via the wired drill pipes.

5. The method of claim 1, wherein the comparing comprises:
comparing an attenuation measurement of the first resistivity to an attenuation measurement of the second resistivity; and
comparing a phase measurement of the first resistivity to a phase measurement of the second resistivity.

6. The method of claim 1, wherein the identifying comprises determining whether a difference between a value of the first resistivity and a value of the second resistivity corresponding to a given depth of the wellbore exceeds a predetermined threshold, wherein the threshold corresponds to level of ballooning attributable to the formation at the given depth of the wellbore.

7. The method of claim 6, further comprising comparing the difference to a plurality of thresholds to determine which of a plurality of levels of ballooning is attributable to the formation at the given depth of the wellbore.

8. The method of claim 1, further comprising setting a value of a threshold against which a difference between a value of the first resistivity and a value of the second resistivity is compared, the value of the threshold based on at least one of the value of the first resistivity and the value of the second resistivity at a same wellbore depth.

9. The method of claim 1, further comprising:
computing a moving average of the first resistivity and a moving average of the second resistivity; and
wherein the comparing comprises computing a difference of the moving average of the first resistivity and the moving average of the second resistivity; and
wherein the identifying comprises comparing the difference to a predetermined threshold, wherein the threshold corresponds to level of ballooning attributable to the formations at the given depth of the wellbore.

10. A system for identifying a ballooning zone in downhole formations, comprising:
a drill string, comprising:
a plurality of wired drill pipes communicatively coupled end-to-end; and
a bottomhole assembly coupled the drill pipes and comprising a tool configured to measure formation resistivity; and
a formation analyzer configured to:
compare a first formation resistivity value of a wellbore formation measured by the tool while drilling to a second formation resistivity value of the wellbore formation measured by the tool while not circulating drilling fluid through into the wellbore; and
classify the formation as belonging to one of a plurality of ballooning levels based on a result of the comparison.

11. The system of claim 10, wherein the bottomhole assembly is configured to transmit the second formation resistivity value to the surface via the wired drill pipes.

12. The system of claim 10, wherein the formation analyzer is configured to determine whether a gain in drilling fluid while not drilling is caused by ballooning.

13. The system of claim 10, wherein the formation analyzer is configured to:
compare an attenuation value of the first formation resistivity value to an attenuation value of the second formation resistivity value; and
compare a phase value of the first formation resistivity value to a phase value of the second formation resistivity value.

14. The system of claim 10, wherein the formation analyzer is configured to determine whether a difference between the first formation resistivity value and the second formation resistivity value corresponding to a given depth of the wellbore exceeds a predetermined threshold, wherein the threshold corresponds to level of ballooning attributable to the formation at the given depth of the wellbore.

15. The system of claim 14, wherein the formation analyzer is configured to compare the difference to a plurality of predetermined thresholds to determine which of a plurality of levels of ballooning is attributable to the formation at the given depth of the wellbore.

16. The system of claim 10, wherein the formation analyzer is configured to determine a value of a threshold against which a difference between the first formation resistivity value and the second formation resistivity value is compared.

17. The system of claim 16, wherein the formation analyzer is configured to determine the value of the threshold to be a percentage of a maximum of at least one the first formation resistivity value and the second formation resistivity value at a same wellbore depth.

18. The system of claim 10, wherein the formation analyzer is configured to:
compute a first moving average of the first resistivity values measured while drilling and a second moving average of the second resistivity values measured while not circulating drilling fluid through the wellbore; and
compute differences of the first moving average and the second moving average; and
compare the differences to a predetermined threshold, wherein the threshold corresponds to level of ballooning attributable to the formations at the given depth of the wellbore.

19. The system of claim 10, wherein the first formation resistivity value and the second formation resistivity value comprise resistivity measurements at each of a plurality of frequencies and the formation analyzer is configured to compare the resistivity measurements of the first formation resistivity value and the second formation resistivity value at each of the plurality of frequencies.

20. A formation analyzer for identifying a ballooning zone in downhole formations, comprising:
one or more processors; and
ballooning analysis logic that when executed causes the one or more processors to:
compare a first formation resistivity value of a wellbore formation measured, while circulating drilling fluid through the wellbore, by a logging while drilling formation resistivity measurement tool to a second formation resistivity value of the wellbore formation measured by the tool while not circulating drilling fluid through the wellbore; and
determine whether the wellbore formation causes ballooning based on a result of the comparison.

21. The formation analyzer of claim 20, wherein the ballooning analysis logic, when executed, causes the one or more processors to determine whether a gain in drilling fluid while not drilling is caused by ballooning based on a result of the comparison.

22. The formation analyzer of claim 20, wherein the ballooning analysis logic, when executed, causes the one or more processors to:
compare an attenuation value of the first formation resistivity value to an attenuation value of the second formation resistivity value;
compare a phase value of the first formation resistivity value to a phase value of the second formation resistivity value; and
determine whether the wellbore formation causes ballooning based on at least one of a result of the comparison of attenuation and a result of the comparison of phase.

23. The formation analyzer of claim 19, wherein the ballooning analysis logic, when executed, causes the one or more processors to determine whether a difference between the first formation resistivity value and the second formation resistivity value corresponding to a given depth of the wellbore exceeds a predetermined threshold, wherein the threshold corresponds to a level of ballooning attributable to the formation at the given depth of the wellbore.

24. The formation analyzer of claim 23, wherein the ballooning analysis logic, when executed, causes the one or more processors to compare the difference to a plurality of predetermined thresholds to determine which of a plurality of levels of ballooning is attributable to the formation at the given depth of the wellbore.

25. The formation analyzer of claim 20, wherein the ballooning analysis logic, when executed, causes the one or more processors to determine a value of a threshold against which a difference between the first formation resistivity value and the second formation resistivity value is compared.

26. The formation analyzer of claim 20, wherein the ballooning analysis logic, when executed, causes the one or more processors to:
compute a first moving average of the first resistivity values measured while drilling and a second moving average of the second resistivity values measured while not pumping drilling fluid into the wellbore; and
compute differences of the first moving average and the second moving average; and
compare the differences to a predetermined threshold, wherein the threshold corresponds to level of ballooning attributable to the formation at the given depth of the wellbore.

27. The formation analyzer of claim 20, wherein the first formation resistivity value and the second formation resistivity value comprise resistivity measurements at each of a plurality of frequencies; and wherein the ballooning analysis logic, when executed, causes the one or more processors to:
compare the resistivity measurements of the first formation resistivity value and the second formation resistivity value at each of the plurality of frequencies; and
determine whether the wellbore formation causes ballooning based on a result of the comparison of the resistivity measurements at any of the plurality of frequencies.
